(19) United States
(12) Patent Application Publication
(10) Pub. No.: US 2024/0353606 A1
(43) Pub. Date: Oct. 24, 2024

(54) LIGHT GUIDE PLATE AND LIGHT GUIDE PLATE UNIT

(71) Applicant: OMRON Corporation, KYOTO (JP)

(72) Inventors: Takahiro ONO, Kyoto-shi (JP); Junya FUJITA, Kyoto-shi (JP); Masanori MORI, Kyoto-shi (JP)

(73) Assignee: OMRON Corporation, KYOTO (JP)

(21) Appl. No.: 18/600,756

(22) Filed: Mar. 10, 2024

(30) Foreign Application Priority Data
Apr. 20, 2023 (JP) 2023-069420

(51) Int. Cl. F21V 8/00

(52) U.S. Cl. CPC G02B 6/0036; G02B 6/006

(57) ABSTRACT

A light guide plate (2) includes: a light guide plate body (D) in which prisms (10) as multiple fine concave parts are formed on one surface, the prisms each having a reflective surface; and a transparent ink layer (11), located at a portion other than a design (P) to be illuminated and displayed in a region (R1) in which the prisms (10) are formed in the light guide plate body (D), and filling the prisms (10) of the located portion to set the reflective surface as a non-reflective surface.

### CROSS-REFERENCE TO RELATED APPLICATION

This application claims the priority benefit of Japan application no. 2023-069420, filed on Apr. 20, 2023. The entirety of the above-mentioned patent application is hereby incorporated by reference herein and made a part of this specification.

### BACKGROUND

### Technical Field

The invention relates to a light guide plate and a light guide plate unit.

### Description of Related Art

Conventionally, a light guide plate unit using a light guide plate itself as a display panel is known. The light guide plate unit includes the light guide plate and a light source supplying light to the light guide plate. The light guide plate is fine-machined with a design, such as text or patterns, to be illuminated and displayed. By supplying light from the light source into the light guide plate, the portion that is fine-machined is illuminated and displayed.

Fine-machining is performed on a surface opposite to a light exit surface in the light guide plate. Fine-machining refers to multiple fine concave parts, such as grooves with a small length and a V-shaped cross-section. Multiple fine concave parts are disposed at a portion to be illuminated. The fine concave part has a reflexive surface that reflects light from the light source propagated inside the light guide plate toward the light exit surface. In the following, the fine concave part is also referred to as a prism in the specification.

As a method of producing such a light guide plate, a method using a mold is provided (e.g., Patent Document 1) is provided. In addition, a method of producing a light guide plate by directly forming a prism on a resin plate through laser processing is also provided (e.g., Patent Document 2) is also provided.

### PRIOR ART DOCUMENT(S)

### Patent Document(s)

[Patent Document 1] Japanese Laid-open No. 2022-32301
[Patent Document 2] Japanese Laid-open No. 2000-066029

However, in the case where a light guide plate itself is used as a display panel, the arrangement of prisms in the light guide plate needs to be changed in order to change the design to be illuminated and displayed. Therefore, in the method for producing a light guide plate by using a mold, a mold needs to be produced every time the design is changed, and the cost is increased.

Meanwhile, in the method using laser processing, a mold is not required. However, in the case of producing a light guide plate of a complicated design, the more the prisms are to be formed, the more time-consuming the machining becomes. Compared with the production using molds, the mass productivity is poor.

The invention provides a light guide plate that does not require a mold to be produced for every design and can be produced at a low cost with excellent mass productivity, and a light guide plate unit that includes the light guide plate.

### SUMMARY

An aspect of the light guide plate includes: a light guide plate body, in which multiple fine concave parts are formed on one surface, the fine concave parts each having a reflective surface; and a transparent ink layer, located at a portion other than a design to be illuminated and displayed in a region in which the fine concave parts are formed in the light guide plate body, and filling the fine concave parts of the located portion to set the reflective surface as a non-reflective surface.

### BRIEF DESCRIPTION OF THE DRAWINGS

FIG. 1 is a front view illustrating a display state of a light guide plate unit including a light guide plate according to an embodiment.

FIG. 2 is a cross-sectional view of a field of view taken along a line A-A shown in FIG. 1.

FIG. 3 is an enlarged view of a region B1 shown in FIG. 2.

FIG. 4 is an enlarged view of a region B2 shown in FIG. 2.

FIG. 5 is a schematic view illustrating a state in which light propagated inside the light guide plate according to the embodiment is emitted into a prism.

FIG. 6 is a view illustrating a back surface of the light guide plate body included in the light guide plate according to the embodiment.

FIG. 7 is a view illustrating the back surface of the light guide plate according to the embodiment.

FIG. 8 is a schematic view illustrating a state in which the light propagated inside the light guide plate is emitted into a prism filled with a transparent ink.

FIG. 9 is a front view illustrating a display state of a light guide plate unit including another light guide plate according to the embodiment.

FIG. 10 is a view illustrating a back surface of the another light guide plate according to the embodiment.

FIG. 11 is a cross-sectional view illustrating a light guide plate unit including multiple light guide plates according to the embodiment.

### DESCRIPTION OF THE EMBODIMENTS

An aspect of the light guide plate includes: a light guide plate body, in which multiple fine concave parts are formed on one surface, the fine concave parts each having a reflective surface; and a transparent ink layer, located at a portion other than a design to be illuminated and displayed in a region in which the fine concave parts are formed in the light guide plate body, and filling the fine concave parts of the located portion to set the reflective surface as a non-reflective surface.

According to the configuration, in the region where fine concave parts are formed, the region other than the design, where the transparent ink layer is located, becomes a non-reflective region, and the design portion, where the transparent ink layer is not located, becomes a reflective region to be illuminated.

Accordingly, a mold is not produced for each design, the fine concave parts are formed on one surface, and the light guide plate body is shared, thereby being able to produce the light guide plate of various designs. The shared light guide plate body can be manufactured by using a mold, thus having excellent mass productivity.

According to the light guide plate according to an aspect of the invention, it may also be configured that the fine concave parts are formed on the entirety of the one surface.

According to the configuration, the fine concave parts are formed on the entirety of the one surface of the light guide plate body. Therefore, the light guide plate is adaptable to any design. Accordingly, the versatility of the light guide plate body is increased, and the light guide plate of various designs can be manufactured at a low cost.

A light guide plate unit according to an aspect of the invention includes: the light guide plate according to an embodiment of the invention; a light source, disposed on a side surface of the light guide plate; and a housing, supporting the light guide plate and the light source.

According to the configuration, since a low-cost light guide plate is used, the light guide plate unit itself can also be provided at a low cost.

According to an aspect of the invention, a light guide plate that does not require a mold to be produced for every design and can be produced at a low cost with excellent mass productivity, and a light guide plate unit that includes the light guide plate can be provided.

In the following, embodiments (referred to as “the embodiment” in the following) according to an aspect of the invention is described based on the drawings.

### Embodiment 1

In the following, an embodiment of the invention will be described in detail.

### 1. Application Example

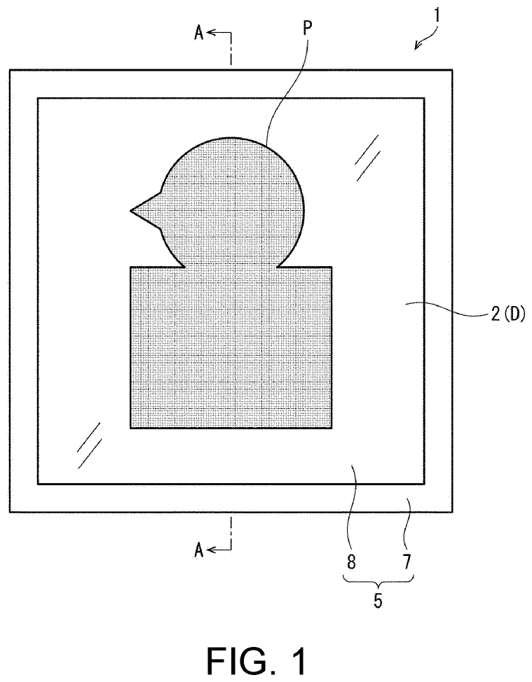

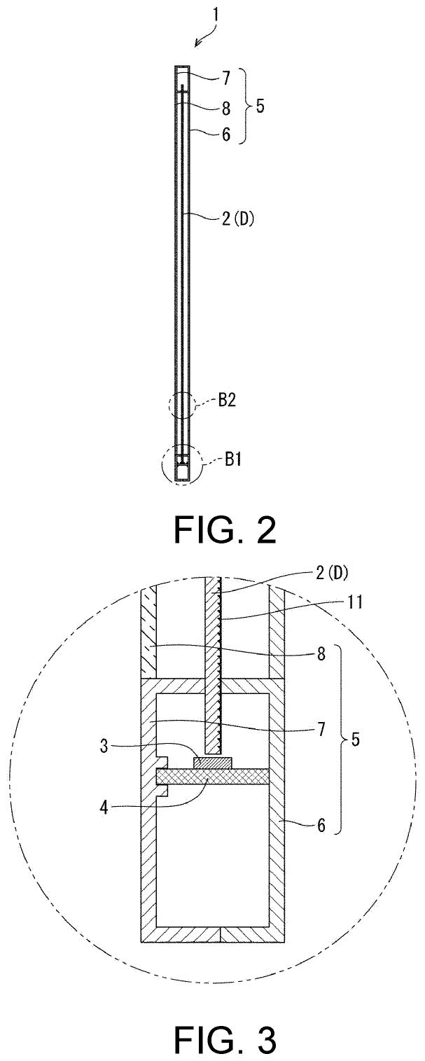

As shown in FIGS. 1 and 2, a light guide plate 2 according to the embodiment can be used in a light guide plate unit 1 using the light guide plate itself as a display panel.

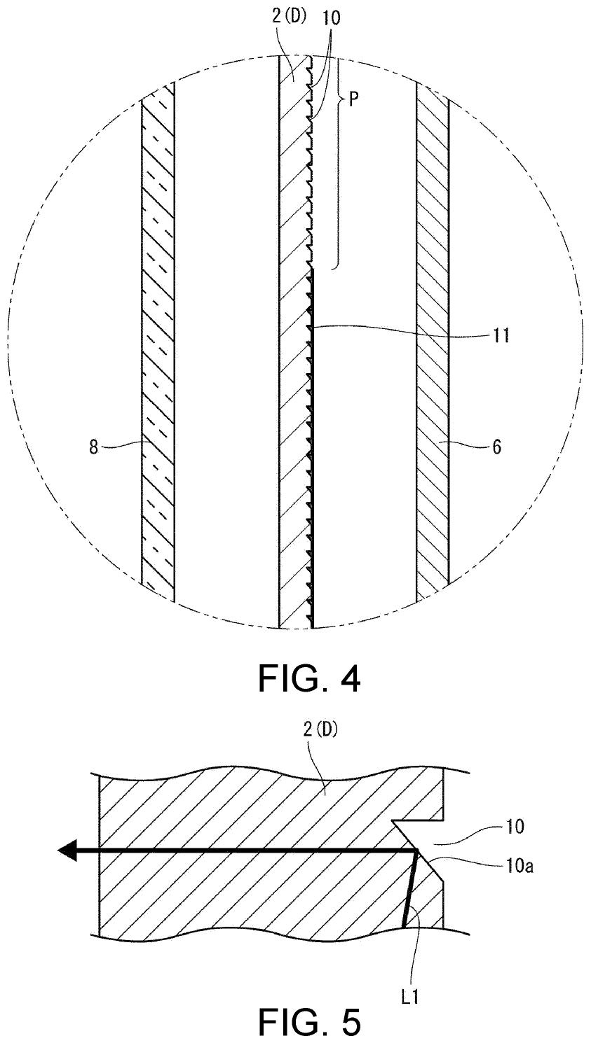

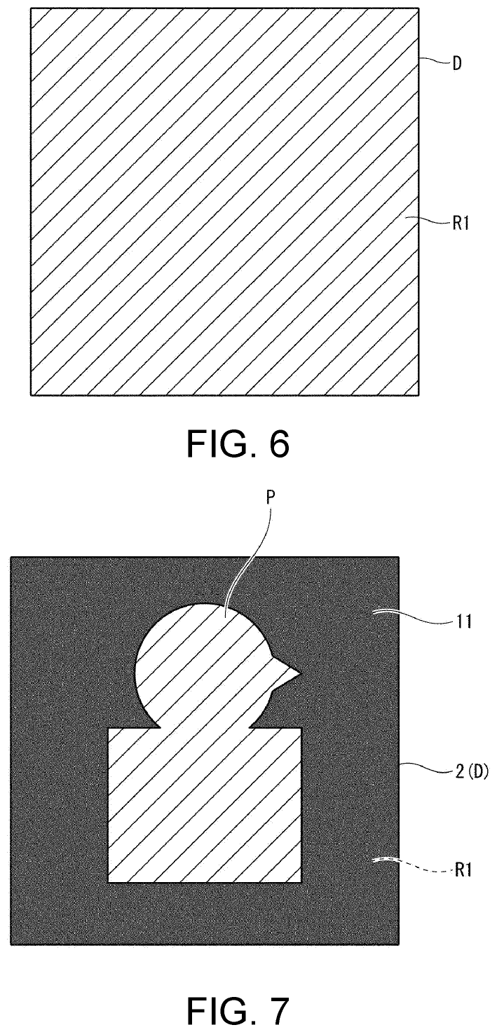

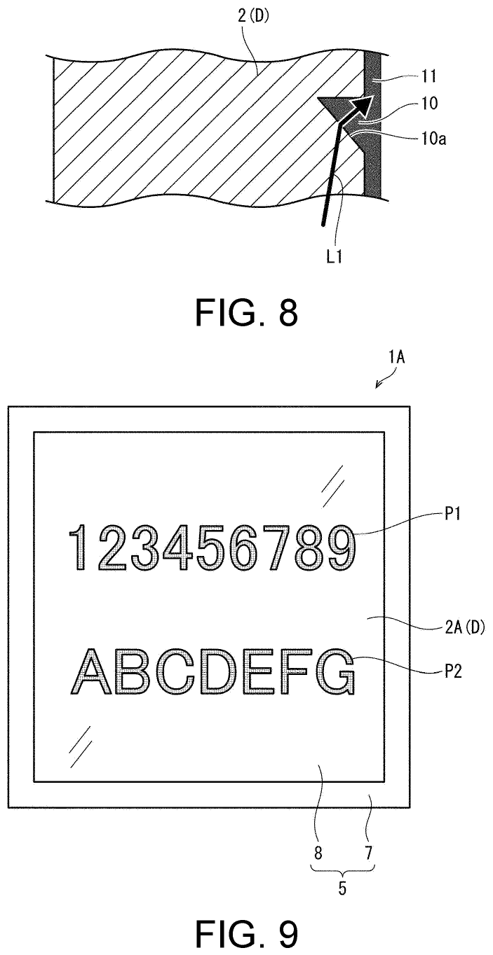

As shown in FIG. 4, the light guide plate 2 has a light guide plate body D and a transparent ink layer 11. Multiple prisms 10 are formed on one surface of the light guide plate body D. The transparent ink layer 11 is located at a portion other than a design P to be illuminated and displayed in a region in which the prisms 10 are formed in the light guide plate body D. The transparent ink layer 11 sets a reflective surface 10a (see FIGS. 6 and 8) as a non-reflexive surface by filling the prisms 10 at where the transparent ink layer 11 is located with a transparent ink.

In such configuration, since the design P is formed at the position where the transparent ink layer 11 is disposed, even if the design P to be illuminated and displayed differs, the light guide plate body D in which the prisms 10 are formed on one surface can be shared. Therefore, the light guide plate 2 can be manufactured at a low cost.

### 2. Configuration Example

In the following, an embodiment of the invention will be described in detail.

### (Light Guide Plate Unit)

FIG. 1 is a front view illustrating a display state of the light guide plate unit 1 including the light guide plate 2 according to an embodiment. FIG. 2 is a cross-sectional view of a field of view taken along a line A-A shown in FIG. 1. FIG. 3 is an enlarged view of a region B1 shown in FIG. 2. FIG. 4 is an enlarged view of a region B2 shown in FIG. 2. FIG. 5 is a schematic view illustrating a state in which light propagated inside the light guide plate 2 according to the embodiment is emitted into a prism.

As shown in FIGS. 1 to 3, the light guide plate unit 1 includes the light guide plate 2, a light source 3 disposed on a side surface of the light guide plate 2, and a housing supporting the light guide plate 2 and the light source 3. A display part is formed by the light guide plate 2 and the light source 3. The light source 3 is disposed on a light source mounting substrate 4 (see FIG. 3), such as an LED substrate.

As an example of the light source 3, an LED can be used. In the case of a full-color LED, the lighting color of the light guide plate 2 can be changed into various colors.

The housing 5 has a bottom case 6, a frame-shaped frame 7, and a transparent panel 8 fit into an opening 7a of the frame 7. The bottom base 6 is a housing covering the back surface of the light guide plate unit 1. The frame 7 and the transparent panel 8 are a housing covering a front surface of the light guide plate unit 1. The bottom base 6 and the frame 7 are usually formed by an opaque material.

The light guide plate 2 is a display panel, and includes the light guide plate body D. The light guide plate body D is a thin resin part formed by a transparent resin, such as acrylic or polycarbonate. In the light guide plate body D, a design P (see FIG. 1) to be illuminated and displayed is formed by multiple fine concave parts.

As shown in FIG. 4, the prisms 10, which are fine concave parts (fine-machined), are formed on the back surface, which is one surface, of the light guide plate body D. As shown in FIG. 5, the prism 10 has a reflexive surface 10a that reflects the light (arrow sign L1) of the light source 3 emitted into the light guide plate body D toward a light exit surface side. The front surface side opposite to the back surface where the prisms 10 are formed in the light guide plate body D is the light exit surface of the light guide plate 2.

By providing multiple prisms 10 along the design P, as shown in FIG. 1, the design P is illuminated and visually recognizable. The light guide plate 2 is disposed so that the light exit surface is opposite to the transparent panel 8. The side where the transparent panel 8 is provided is the viewer side of the light guide plate unit 1.

### (Light Guide Plate)

Then, the light guide plate 2 is described in detail by using FIGS. 1 and 4 to 8. FIG. 6 is a view illustrating the back surface of the light guide plate body D included in the light guide plate 2 according to the embodiment. FIG. 7 is a view illustrating the back surface of the light guide plate 2 according to the embodiment. FIG. 8 is a schematic view illustrating a state in which light propagated inside the light guide plate 2 according to the embodiment is emitted into the prism 10 filled with a transparent ink.

As shown in FIG. 4, the light guide plate 2 has the light guide plate body D and the transparent ink layer 11. The prisms (fine concave parts) 10 each have a reflexive surface and are formed on one surface of the light guide plate body D. The transparent ink layer 11 is located at a portion other than the design P to be illuminated and displayed in a region in which the prisms 10 are formed in the light guide plate body D. The transparent ink layer 11 sets the reflective surface 10a as a non-reflexive surface by filling the prisms 10 at where the transparent ink layer 11 is located with the transparent ink.

As shown in FIG. 6, in the light guide plate body D, the prisms 10 are formed in a wide region on the back surface. In FIG. 6, a region R1 where the prisms 10 are formed in the light guide plate body D is represented by oblique lines. The light guide plate body D is manufactured by using a mold.

In the embodiment, the prisms 10 are formed on the entire back surface of the light guide plate body D. When light is provided by the side surface of such light guide plate body D, the entire surface of the light guide plate body D is illuminated. The light guide plate 2 is produced by using, as a base material, such light guide plate body D where the prisms 10 are formed in the wide region on the back surface.

Although a configuration in which the prisms 10 are formed on the entire back surface of the light guide plate body D is exemplified in the embodiment, it suffices as long as the prisms 10 are formed in a wide region (wide range) on the back surface (a surface) of the light guide plate body D. That is, the back surface (a surface) of the light guide plate body D may also include a portion where the prisms 10 are not formed.

As shown in FIG. 7, the transparent ink layer 11 is arranged to form the shape of the design P on the back surface of the light guide plate body D. In FIG. 7, the region where the transparent ink layer 11 is disposed is shown by using a solid image. The portion represented by oblique lines in FIG. 7 is a portion where the transparent ink layer 11 is not disposed in the region R1 where the prisms 10 are formed.

When the design P viewed from the viewer side of the light guide plate unit 1 is a display image, the image formed by the transparent ink layer 11 is a negative-positive image of a horizontally reversed image of the display image when viewed from the back surface side of the light guide plate 2. For the formation of such transparent ink layer 11, the formation can be easily carried out by using a printing apparatus, such as an injector printer.

As shown in FIGS. 4 and 8, the transparent ink layer 11 is disposed and coated so that the prisms 10 are filled with the transparent ink. As shown in FIG. 8, the prism 10 filled with the transparent ink allows the light (arrow sign L1) emitted into the reflective surface 10a to pass through without reflecting the light, and the reflective surface 10a becomes a non-reflective surface. By being filled with the transparent ink, the prism 10 is unable to reflect the light of the light source 3 emitted into the light guide plate body D to the light exit surface side.

The light guide plate 2 of such configuration can be easily manufactured by using, as a base material, the light guide plate body D in which the prisms 10 are formed in a wide region on one surface, and forming the negative-positive image of the horizontally reversed image of the design P by using the transparent ink on the surface of the base material where the prisms 10 are formed.

That is, a method for manufacturing the light guide plate 2 includes a step of using, as a base material, the light guide plate surface body D in which the prisms 10 each having the reflective surface are formed on one surface, coating the transparent ink to a portion other than the design P to be illuminated and displayed in the region where the prisms 10 are formed in the light guide plate body D, and setting the reflective surfaces 10a as non-reflective surfaces by filling the prisms 10 of the coated portion by using the transparent ink.

The transparent ink layer 11 is formed by solidifying the transparent ink in a liquid state. As the transparent ink, it suffices as long as a material is transparent and allows light emitted into the reflective surface 10a to pass through toward the inner side of the prism 10 by filling the prism 10. Considering the ease of the prism 10 entering into a cavity, the surface tension may be low, and the wettability with respect to the light guide plate body D may be high. In addition, regarding the refractive index in the solidified state, although the refractive index may be the same as the refractive index of the light guide plate body D or a refractive index close to the refractive index of the light guide plate body D, it suffices as long as the reflective surface 10a has a refractive index of a non-reflective surface.

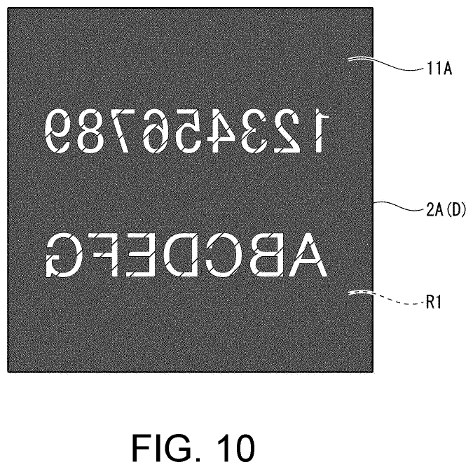

FIG. 9 is a front view illustrating a display state of a light guide plate unit 1A including another light guide plate 2A according to the embodiment. FIG. 10 is a view illustrating the back surface of the light guide plate 2A according to the embodiment.

As shown in FIG. 9, designs P1, P2 to be illuminated and displayed on the light guide plate unit 1A are text strings “123456789” and “ABCDEFG”. In such case, as shown in FIG. 10, a transparent ink layer 11A of a positive-negative image of a horizontally reversed image of the text strings “123456789” and “ABCDEFG” is formed on the back surface of the light guide plate 2A.

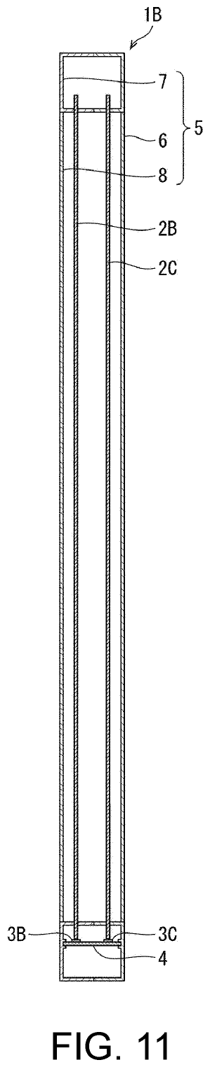

FIG. 11 is a cross-sectional view illustrating a light guide plate unit 1B including multiple light guide plates. As shown in FIG. 11, in light guide plates 2B and 2C, light exit surfaces are respectively disposed to be overlapped in parallel toward the viewer side of the light guide plate unit 1B. Light sources 3B, 3C disposed on side surfaces of the light guide plates 2B, 2C are mounted on the light source mounting substrate 4. Light sources 3B, 3C corresponding the light guide plates 2B, 2C are formed to be able to be driven respectively and independently.

Although the design patterns to be illuminated in the light guide plates 2B, 2C are different, it can be configured that the light guide plate body D is used and only the image formed on the back surface by using the transparent ink layer 11 is changed in accordance with the design to be illuminated.

In addition, while not shown in the drawings, the light guide plate units 1 to 1B may also include a switch part, such as a press button switch. The switch part may also be disposed on the display part. That is, openings may be formed on the light guide plates 2 to 2C, and the switch parts are formed in the openings.

### (Effects)

According to the configuration, the transparent ink layer 11 located in the region of a portion of the region R1 in which the prisms 10 are formed sets the reflective layers 10a to be non-reflective surface by filling the prisms 10 with the transparent ink. Therefore, the light guide plate body D in which the prisms 10 are formed in a wide region is adopted as the base material, the design P to be illuminated and displayed is left, and the transparent ink layer 11 is disposed in the portion other than the design P to serve as a non-reflective region, thereby being able to change the design P to be displayed in various way without changing the mold.

Although a mold is required in the production of the light guide plate body D serving as the base material, the mold can be shared and is irrelevant of the design P to be displayed. Therefore, the mold can be manufactured at a low cost. Although the position where the transparent ink layer 11 is disposed needs to be changed for each design P, the change can be easily made by using conventional techniques such as an inkjet printer. Accordingly, a light guide plate having excellent mass productivity and manufactured at a low cost without requiring a mold for each design can be provided.

In addition, in the embodiment, since the fine prisms 10 are formed on the entire back surface of the light guide plate body D, the light guide plate is adaptable to any design. Accordingly, the light guide plate body in which fine concave parts are formed in the wide region before the transparent ink layer 11 is provided becomes versatile, and the light guide plate of various designs can be manufactured at an even lower cost.

The invention is not limited to the embodiments described above, and various changes can be made within the scope of the claims. Embodiments obtained by appropriately combining technical means disclosed in different embodiments are also included in the technical scope of the invention.

What is claimed is:

1. A light guide plate, comprising:
a light guide plate body, in which a plurality of fine concave parts are formed on one surface, wherein the fine concave parts each have a reflective surface; and
a transparent ink layer, located at a portion other than a design to be illuminated and displayed in a region in which the fine concave parts are formed in the light guide plate body, and filling the fine concave parts of the located portion to set the reflective surface as a non-reflective surface.

2. The light guide plate as claimed in claim 1, wherein the fine concave parts are formed on an entirety of the one surface.

3. A light guide plate unit, comprising:
the light guide plate as claimed in claim 1;
a light source, disposed on a side surface of the light guide plate; and
a housing, supporting the light guide plate and the light source.
